(19) United States
(12) Patent Application Publication
(10) Pub. No.: US 2003/0134074 A1
(43) Pub. Date: Jul. 17, 2003

(54) Surface enhancement and modification system

(76) Inventors: James M. Scolaro, Racine, WI (US); Robert P. Sander, Racine, WI (US); Shwn-meei Y. Linden, Racine, WI (US); Jamey Gaston, Racine, WI (US); Steven B. Harris, Franklin, WI (US)

Correspondence Address: S.C. JOHNSON COMMERCIAL MARKETS INC, 8310 16TH STREET, M/S 510, PO BOX 902, STURTEVANT, WI, 53177-0902, US

(21) Appl. No.: 10/323,073

(22) Filed: Dec. 18, 2002

Related U.S. Application Data
(60) Provisional application No. 60/342,549, filed on Dec. 20, 2001.

(51) Int. Cl. B32B 9/00

(52) U.S. Cl. 428/40.1

(57) ABSTRACT

This invention provides a thin unsupported indicia containing layer for modifying the appearance of a surface. The indicia containing layer may be contained in a laminate structure that includes an adhesive coating applied to the lower surface of the indicia containing layer, at least one removable protective layer, and a release coating for facilitating the transfer of the indicia containing layer from the removable protective coating onto the surface to be modified. The invention also provides methods and systems for modifying the appearance of a surface using the indicia containing layer.

### CROSS REFERENCE TO RELATED APPLICATIONS

This application claims priority from U.S. Provisional Application No. 60/342,549, filed Dec. 20, 2001, the entire disclosure of which is incorporated herein by reference.

### FIELD OF THE INVENTION

This invention provides an unsupported indicia containing layer for modifying a surface, surfaces modified with the unsupported indicia containing layer, and methods for modifying the appearance of a surface with the indicia containing layer.

### BACKGROUND OF THE INVENTION

Floor care programs today are primarily used to both protect and enhance the appearance of a floor substrate. A variety of materials including vinyl, marble, terrazzo, ceramic, linoleum, wood, etc. are used as floor substrates. Floor care programs can include many different types of products, but generally involve the use of a sealer and/or finish applied to the surface of the floor substrate. This finish is then maintained with the use of cleaners and tools, which can include various buffing or burnishing machines. Although these programs are very effective they are considered a large expense to customers. Additionally, if a surface becomes worn or unsatisfactory over time, it is necessary to entirely remove the floor substrate, to provide a new fresher look to the floor.

In retail locations it is commonplace to place advertising and/or directions in locations readily visible to the customer or client. Recently, several companies have begun producing floor graphics to meet the needs of advertisers. These graphics consist of a printed film covered with some kind of permanent coating meant to both protect the graphic and provide a non-slip surface. Unfortunately, many of the floor stickers available today fail to meet ASTM standards for slips and falls. These graphics, which are applied over the floor finish, are very similar to a sticker in that a backing is peeled off of the graphic, exposing an adhesive. The sticker is then pressed down onto the floor finish. Such stickers are utilized by a variety of end users, but are primarily found in industrial and retail locations where informational data or advertising play an important role in impulse purchasing.

There are many product defects or deficiencies which make the presently available types of graphics less than desirable for use in flooring and other surface applications. These include distorted image, difficulty in application, wearing or tearing of the sticker, difficult maintenance due to use of mechanical equipment used in the floor care process which tends to tear up the edges of the graphic, and thickness of the graphic. Most often these deficiencies result in a poor appearance, low durability and a trip, slip and fall hazard for individuals walking over or around the graphic. Additionally, such graphics tend to accumulate dirt, especially where damage to the graphics has occurred and adhesive residue remains. Further, existing graphics are difficult to remove and sometimes take several coats of the surface finish off during removal thereby requiring that the entire surface be stripped and recoated with a finish. None of these products addresses the situation where it is desirable to change the appearance of the entire surface or a large portion of the surface.

In summary, a considerable number of deficiencies exist in the art relating to appearance modification and enhancement systems related to indoor and outdoor surfaces, such as floor surfaces, wall surfaces, ceilings, windows, vehicle surfaces, driveways, sidewalks, patios, and the like. While prior art stickers provide a means for advertising and including a graphic on a sticker, the poor print quality, difficult application, difficult maintenance, thickness, poor adhesion and/or wearing and tearing, low durability and labor intensive and expensive removal and recoating process make them less than desirable, expensive and time consuming options. Additionally, the danger posed by the worn or lifted edges of such stickers creates a safety hazard. Further, the appearance of such stickers is not very professional and is oftentimes dull or less than crisp. Additionally, when it is desirable to modify the appearance of the entire surface or large portions thereof, few options other than the expensive removal and replacement of the substrate exist.

Thus, there is an ongoing search for an appearance modification system which would enable a surface to be altered partially or in its entirety, which can be quickly and easily applied yet is readily removable and protected from scratches, scuffs, gouges and other damage by maintenance equipment and general wear and tear. In particular, there is a need for an improved appearance modification system which overcomes the shortcomings of the stickers of the prior art.

### SUMMARY OF THE INVENTION

One aspect of the invention provides a surface modifying laminate structure containing a thin unsupported indicia containing layer. Other optional layers in the laminate include a bonding coat for attaching the indicia containing layer to a surface, at least one removable protective layer for protecting the indicia containing layer and/or any adhesive layer prior to the application of the indicia containing layer to a surface, and a release coating between the indicia containing layer and the removable protective layer.

Another aspect of the invention provides a surface modification system which includes an indicia containing layer, optionally a top coat applied over the indicia containing layer and a surface onto which the system is to be applied. The indicia containing layer in such a system is sufficiently thin to provide a minimal difference between the height of the surface without the indicia containing layer and the height of the surface including such a layer. The indicia containing layer may be disposed on at least a portion of the surface whereby the remaining portion of the surface is devoid of any indicia containing layer. Alternatively, the indicia containing layer may cover the entire surface. In some embodiments at least one top coat is applied over the indicia containing layer, or at least a portion thereof, and at least a portion of the surface adjacent the indicia containing layer. In some embodiments the system may include at least one base coat applied to the surface prior to application of the indicia containing layer.

The indicia containing layer for use in the surface modification system may be made from a pigmented layer. In some embodiments, the pigmented layer is readily dissolvable and may be removed simultaneously with the top coat of the system. The indicia containing layer is thinner than other presently available surface graphics. In some embodiments the indicia containing layer has a thickness of 8 mils or less, where a “mil” is one one-thousandth of and inch. This includes embodiments where the indicia containing layer has a thickness of 6 mils or less, embodiments where the indicia containing layer has a thickness of 5 mils or less, embodiments where the indicia containing layer has a thickness of 4 mils or less, and embodiments where the indicia containing layer has a thickness of 3 mils or less.

The inventive system may also provide a system for applying an indicia containing layer to a surface. The system may include an applicator for applying the indicia containing layer to a surface. The applicator can include a dispenser for distributing or dispensing the indicia containing layer, and an elongated member disposed adjacent to the dispenser to uniformly and temporarily or permanently position the indicia containing layer on a surface to be modified. In one embodiment, the applicator may include a roller mechanism for dispensing an elongated roll of previously printed indicia containing layers onto a surface or multiple surfaces. Alternatively, the indicia containing layer applicator can include a print head movably mounted such that during application of the indicia containing layer to a surface the print head can be oriented in a parallel manner with the surface to be coated. Such an apparatus can optionally include a drying mechanism such as a blower or fan, or heat applicator to assist in the drying of any print or graphic detail. Such an applicator can additionally include a mechanism for movably supporting the print head above a surface such as wheels or pads to allow for smooth incremental movement of the applicator across a surface. In such an embodiment the indicia containing layer may include one or more pigmented regions, rather than a continuous pigmented film. Because of simultaneous creation and application no removable layer is necessary in this embodiment.

The inventive system also optionally includes a surface cleaner for cleaning a surface to which an indicia containing layer has been applied. Such cleaners include neutral cleaners, alkaline cleaners, acidic cleaners, cleaner/maintainers and maintainers, including polymeric type cleaners. During surface cleaning the indicia containing layer remains intact and is not degraded or damaged by the cleaning material or process.

A surface stripper is also optionally included in the present inventive system. Such a surface stripper may be designed to penetrate the top coat. Additionally, the indicia containing layer may be penetrated such that the indicia containing layer is readily dissolved or delaminates from the base coat or the surface in a manner that facilitates cleanup and removal without the necessity of use of mechanical abrasive material and/or equipment. In one embodiment, the indicia containing layer may include small perforations to facilitate penetration of the stripper.

A pigmented formulation suitable for use in a surface enhancement system of the present invention can include conventional pigmented formulations known to one of ordinary skill in the art. In some embodiments the pigmented formulation is readily dissolvable or penetrable by conventional stripping compositions.

Additionally, a bonding system for adhering the indicia containing layer to a surface is provided. This system may be selected to attach the indicia containing layer in a removable or repositionable manner. Such a bonding system can include a pressure sensitive adhesive such that the pressure sensitive adhesive has sufficient tack to hold the indicia containing layer at a fixed position for a sufficient duration to enable the placement of a top coat over at least a portion of the indicia containing layer and at least a portion of the surface. Alternatively, a repositionable adhesive can be utilized. Further options include the use of static electricity and/or friction to position the indicia containing layer at a fixed location on a surface to enable the placement of a top coat over at least a portion of the indicia containing layer and a portion of the surface to be treated.

In practice, application of the indicia containing layer to a surface comprises the following steps. It is advisable, but not required, that the surface be properly cleaned prior to the application of the indicia containing layer to remove dirt or debris which may adversely affect the overall appearance of the surface with the indicia containing layer affixed thereto. For example, the floor may be dust mopped with a micro-fiber type sweeping tool. The next step involves positioning or disposing an indicia containing layer on at least a portion of the surface. After such positioning, a top coat may be applied over at least a portion of the indicia containing layer and the surface. The top coat may be applied over the entire indicia containing layer and at least a portion of the surface. In some embodiments a base coat layer can be applied to the surface after the cleaning step but prior to positioning the indicia containing layer on the surface.

In a process for removing an indicia containing layer from an enhanced surface wherein at least a portion of the surface includes an indicia containing layer which is optionally disposed below a top coat, a conventional stripper can be applied to the surface including the indicia containing layer disposed on at least a portion of the surface. Ideally, the stripper will penetrate the top coat and the indicia containing layer, and then the indicia containing layer and the top coat may be removed by conventional means. This includes mopping, vacuuming, etc. Alternatively, the stripper may penetrate the top coat and a base coat applied directly to the surface and release the indicia containing layer along with the base coat from the surface. The resulting waste is then removed from the floor by conventional means.

While the present invention enables the easy application and removal of an indicia containing layer it also provides for methods of maintaining a surface which includes an indicia containing layer disposed on at least a portion thereof. Such methods involve applying a commonly used cleaner to the surface, including the portion of the surface containing the indicia containing layer, and removing the cleaner in a conventional manner or allowing it to dry. Such application and maintenance does not involve any degradation or damage to the indicia containing layer and such layer maintains its original position and appearance on said surface. In alternative methods of maintenance, agitation, such as by a buffer, can be utilized on the surface, including the portion of the surface containing the indicia containing layer, without degradation or damage such that the indicia containing layer remains intact.

### BRIEF DESCRIPTION OF THE DRAWINGS

FIG. 1 is a cross-sectional view illustrating a prior art sticker system.

FIG. 2 is a cross-sectional view of a surface to which the appearance enhancement or modification system of the present invention has been applied.

FIG. 3 is a cross-sectional view of a surface to which an alternative embodiment of the appearance modification system of the present invention has been applied.

FIG. 4 is a cross-sectional view of a surface to which an alternative embodiment of the present inventive appearance modification system has been applied.

FIG. 5 is a cross-sectional view of an embodiment of an indicia containing layer of the present invention.

FIG. 6 is a cross-sectional view of a surface to which another embodiment of the invention has been applied.

FIG. 7 is a cross-sectional view of a surface to which another embodiment of the invention has been applied.

FIG. 8 is a perspective view of an application apparatus used to apply the invention to a surface.

FIG. 9 is a perspective view of an application technique used to apply the invention to a surface.

FIG. 10 is a perspective view of an applicator used to apply the invention to a surface.

### DETAILED DESCRIPTION OF THE PREFERRED EMBODIMENTS

The present invention is directed to an appearance modification system used to modify or enhance a surface, such as a floor, wall, vehicle surface, countertop, door, billboard, and the like. Such a system would enable modification or enhancement of a surface, such as a floor, with visual images and/or text disposed on at least a portion of the surface. Alternatively, the entire appearance or color of the surface can be modified.

The present invention has potential applications on any surface where visual images, text, color, graphics and/or designs can be applied to provide a modified visual appearance of the surface. Such surfaces may be found both indoors and outdoors on such objects as architectural structures, vehicles and consumer products. As used herein, the term architectural structure includes building structures, such as floors, walls, ceilings, windows, roofs, patios, shelves, and stairs, and ground cover structures, such as roads, driveways, and sidewalks. Examples of vehicles to which the surface modifying systems may be applied include, automobiles, aircraft, watercraft, trucks, motorcycles, and bicycles. Toys and appliances are only two of many consumer products to which the surface modifying systems may be applied. The surface to be modified may be made from a vast variety of materials, including, but not limited to, vinyl, marble, terrazzo, ceramic, linoleum, wood, metal, plastic, rubber, gypsum board, plaster, concrete, stone, vinyl composition tile, and glass. Potential applications also extend into the printing market as a whole.

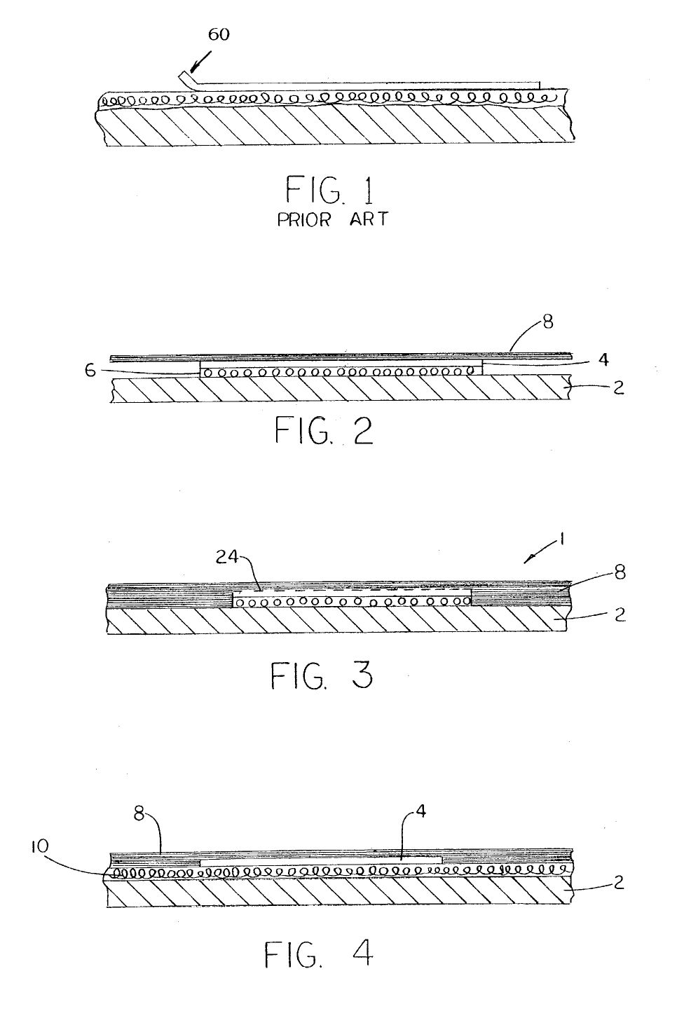

FIG. 2 shows one exemplary embodiment of the invention. As shown in this figure, the indicia containing layer may be part of a laminate structure to provide a surface modifying laminate. In this embodiment, a surface 2 to be modified is at least partially covered by an indicia containing layer 4, a bonding coat 6, and a top coat 8. Other exemplary embodiments are shown in FIGS. 3, 4, 6, and 7. As shown in FIG. 4, at least one base coat 10 may be disposed between the surface 2 and the indicia containing layer 4. As shown in FIG. 5, the indicia containing layer 4 of the present invention can include a graphic or colored pigmented layer 12 and a release coat 14 dispersed thereon. Additionally, the present invention can include removable protective layers 16 and 18. Removable protective layer 16 is designed to protect the top of the printed graphic or colored pigmented layer 12 and removable protective layer 18 is designed to protect the lower portion of the graphic or colored pigmented layer 12. The printed graphic or colored pigmented layer 12 may be a UV cured ink, a water based ink, or a solvent based ink. In some embodiments the ink formulation is a 100% active formulation. It is advantageous, but not necessary, for the ink to be removable or penetrable by common strippers which will be discussed later.

The indicia containing layer 4 is typically a graphic or colored pigmented layer 12 made from an ink formulation which may contain any suitable ink, dye, or pigment that is capable of being applied, for example by dry transfer, to a surface in a thin layer. The indicia containing layer may be a continuous layer that covers the entire surface to be modified. Because a floor surface that is entirely covered has a single uniform coefficient of friction, the risk of slipping on the surface is reduced in such embodiments. In some embodiments the graphic provided by the indicia containing layer gives the appearance of a painted graphic or even a photograph. UV cured inks are an example of a suitable family of inks that may be used in the indicia containing layer. In some embodiments, the ink, pigments, or dyes are readily dissolvable in water or common organic solvents, are readily removable, and do not migrate or diffuse into the adjacent base coat or top coat of the finish system. This includes water based and solvent based ink formulations. The indicia containing layer may be a multi-colored layer and the inks, dyes, and/or pigments that make up the layer may be contained in a single stratum or multiple strata within the indicia containing layer.

The indicia containing surface is unsupported, which, as used herein, means the indicia containing layer is a discrete layer that may be applied or transferred separately from any supporting substrate, such as fabrics, foils, paper, or polymeric sheeting. For example, the indicia containing layer may be a thin film made from inks, dyes, and pigments, and optionally additives. Such layers are distinguishable from indicia (e.g. text, images, graphics, etc.) applied to or printed onto a substrate wherein both the substrate and the indicia thereon are transferred to a surface to be modified. As shown in FIG. 3, alternative embodiments of the present invention can include holes or perforations 24 in the indicia containing layer 4 to allow for penetration of a stripper for easier removal.

The present invention may optionally include a bonding coat 6 on one surface of the indicia containing layer as shown in FIG. 2. Such a bonding coat 2 can comprise an adhesive, friction, static or water slide. In embodiments having a bonding coat, the bonding coat may be transferred along with the indicia containing layer to the surface to be modified. The bonding coat should be thin in order to minimize the combined thickness of the bonding layer plus the indicia containing layer. In various embodiments the combined thickness of the indicia containing layer and the bonding coat is 8 mils or less, 6 mils or less, 5 mils or less, 4 mils or less and even 3 mils or less. Possible adhesives can include pressure sensitive adhesives, temperature sensitive adhesives, repositionable adhesives, or any other suitable adhesive known to one of ordinary skill in the art. Pressure sensitive acrylic adhesives are suited for use in the bonding coat of the invention. The tackiness of the pressure sensitive adhesives may vary over a wide range and will depend in part on the surfaces and the amount of surface to be covered. However, in some embodiments the adhesives have a tackiness of less than 80 pounds per square inch. This includes embodiments where the adhesives have a tackinesss of less than 40 pounds per square inch, and further includes embodiments where the adhesives have a tackiness of less than one pound per square inch. Once the laminate structure is bonded to the surface, the adhesives may have high adhesion. In some embodiments the adhesion is greater than about 25 oz/in. This includes embodiments where the adhesion is greater than about 30 oz/in and embodiments where the adhesion is greater than 50 oz/in. In certain embodiments the adhesion is from about 30 to about 95 oz/in.

The adhesive may be applied directly to the indicia containing layer or may first be applied to the surface of a protective removable layer, of the type described below, which is then disposed adjacent to the indicia containing layer, sandwiching the adhesive coating between the indicia containing layer and the removable protective layer. In this embodiment it is advantageous if the adhesive bonds preferentially to the indicia containing layer. The bonding coat may be applied to the surface of the indicia containing layer or the protective layer by any conventional means. For example, the adhesive may be spray coated, rolled or printed onto the indicia containing layer or protective layer. In some embodiments the adhesive dissolves readily in mild detergents.

In some embodiments, the bonding coat may be omitted. For example, an external source may be utilized to maintain the position of the indicia containing layer on the surface to be modified during application of a top coat 8 over at least a portion of the indicia containing layer 4 such that the top coat secures the indicia containing layer to the surface. Alternatively, the indicia containing layer may be printed directly onto the surface to be modified and subsequently covered, at least in part, by a top coat. In other embodiments, the indicia containing layer itself includes adhesives such that the indicia containing layer provides a pigmented adhesive layer, making a separate bonding layer unnecessary.

As shown in FIG. 5, the indicia containing layer may optionally include a removable protective layer disposed on one or both surfaces of the indicia containing layer. In one embodiment the indicia containing layer is reverse printed onto a removable protective layer so that the graphic has the proper orientation when applied to the surface to be modified. In this construction the removable protective layer is disposed above the surface of the indicia containing layer that will be face-up with respect to the surface to be modified after application. For convenience, this “face-up” surface will be referred to as the “top” surface of the indicia containing layer and the removable protective layer thereon will be referred to as the “upper” removable protective layer. This removable protective layer protects the indicia containing layer from damage during handling. A release coating may be included between the removable protective layer and the indicia containing layer in order to facilitate the transfer of the indicia containing layer to the surface to be modified. When a release coating is present, the indicia containing layer may be applied or printed onto the release coating. In some embodiments the indicia containing layer includes a lower removable protective layer disposed next to the surface of the indicia containing layer that is intended to be face-down on the surface to be modified after application (i.e. the “bottom” surface). In such applications a bonding coat as described above, may be included between the removable protective layer and the bottom surface of the indicia containing layer. In this construction the removable protective layer serves to prevent debris from collecting in the adhesive and to prevent the adhesive from attaching to a surface prematurely.

The removable protective layer on the top and bottom surfaces of the indicia containing layer may be made from the same or different materials. Suitable materials include, but are not limited to, plastics, such as polyester, polypropylene, or polyethylene, or other suitable material to act as a carrier of the indicia containing layer and protect the upper and lower portions of the printed graphic or colored pigmented layer. The removable protective layer may optionally be a transparent material. In some embodiments the removable protective layer or layers are paper which may optionally be a coated paper. This has the advantage of significantly lowering the cost of production of the surface modifying laminates. In addition, because the paper may be readily recycled, this embodiment saves energy and reduces waste.

Suitable materials for use in the release coat are well known and include, but are not limited to, polyvinyl chloride and acrylics designed to facilitate the release of the removable layer 16 from the printed graphic or colored pigmented layer 12. The release coat may be designed to remain substantially adhered to the removable protective layer after the transfer of the indicia containing layer to the surface to be modified. Alternatively, the release coat may be designed to remain substantially adhered to the indicia containing layer after the transfer. In the latter design, the release coat is referred to as a breakaway coating. The breakaway coating should be selected and designed such that it does not substantially affect the thickness of the applied indicia containing layer and assimilates with the indicia containing layer without negatively affecting the appearance of that layer. In other embodiments the release coat is split between the indicia containing layer and the removable protective layer upon the removal of the latter. In various embodiments, the combined thickness of the indicia containing layer, any bonding coat and any release coating is 8 mils or less, 6 mils or less, 5 mils or less, 4 mils or less, or even 3 mils or less.

After the application of the indicia containing layer to the surface to be modified, at least one top coat may be disposed over at least a portion of the indicia containing layer and over at least a portion of the surface adjacent the indicia containing layer. The top coat may be any conventional sealant or finish and may be applied as a solid or a liquid top coat. Such top coats are well known and commercially available and are generally used to impart shine, dirt resistance, water resistance, and/or scratch/wear resistance to the surface. The top coat may help adhere the indicia containing layer to the surface to be modified and to further smooth out the already extremely narrow edges of the indicia containing layer. Another advantage provided by the top coat is that it provides a surface having a single coefficient of friction which helps prevent trips, slips and falls. However, the top coat is not required. Examples of suitable top coats include, but are not limited to, polymeric top coats, such as acrylic finishes. Specific examples of such top coats include styrene acrylics, urethane acrylics, urethanes, vinyls, epoxys, and the like. In various embodiments, the combined thickness of the indicia containing layer and any top coat is 8 mils or less, 6 mils or less, 5 mils or less, 4 mils or less, or even 3 mils or less. However, the combined thickness of the top coat or coats and the indicia containing layer may lie outside of these ranges.

Further embodiments of the present invention allow for a first indicia containing layer to be applied directly to a surface, followed by the application of a top coat over the first indicia containing layer, and the subsequent application of a second indicia containing layer disposed over the first top coat, followed by one or more additional top coatings. Further alternating layers of indicia containing layers and top coats can be utilized to achieve a desired effect. Depending on the number of indicia containing layers, the indicia containing layers and top coats can be alternated in an infinite number of steps to provide the desired effect.

Alternatively, the indicia containing layer can be applied directly to the substrate followed by a urethane top coating with additional indicia containing layers positioned on top of the urethane coating. In this embodiment no additional top coat is disposed over the final indicia containing layer. In such an embodiment, as in previous embodiments, a base coating layer can be disposed on top of the surface 2 prior to application of any indicia containing layers.

For example, a first indicia containing layer, which may be embodied in one of the laminate structures described above, is applied to or printed on the surface and a finish or top coat is applied to a least a portion of the surface of the indicia containing layer, and a second indicia containing layer, which may also be embodied in one of the laminate structures described above, is applied to or printed on the surface, over at least a portion of the first indicia containing layer. Optionally, an additional finish or top coat may be applied over the additional surface containing layer to provide a layered structure. For example, the second indicia containing layer may be made from a series of individual portions or patches of indicia containing material. This embodiment is useful because monitoring the degree of disappearance of the second indicia containing layer allows the user to determine when the surface requires reapplication of a top coat over the first indicia containing layer. The ability to provide multiple indicia containing layers is also advantageous because it allows the lower indicia containing layers to be patched in order to fix holes or cover damage.

Additionally, as shown in FIG. 7, at least one base coat 10 may be disposed between the surface 2 to be modified and the indicia containing layer 4. In such an embodiment the indicia containing layer 4 may be applied to or printed directly on the surface 2 or the base coat 10. Suitable base coats are well known and are commercially available. The base coat can be of similar or identical composition to the top coat, as previously discussed. It has been surprisingly and unexpectedly discovered that the addition of a base coat makes removal of the indicia containing layer easier because when a base coat is present beneath the indicia containing layer, the indicia containing layer may be removed simultaneously with the same stripping agents used to remove the base coat. This reduces the time and the amount of stripping agents required for removal, resulting in significant cost savings.

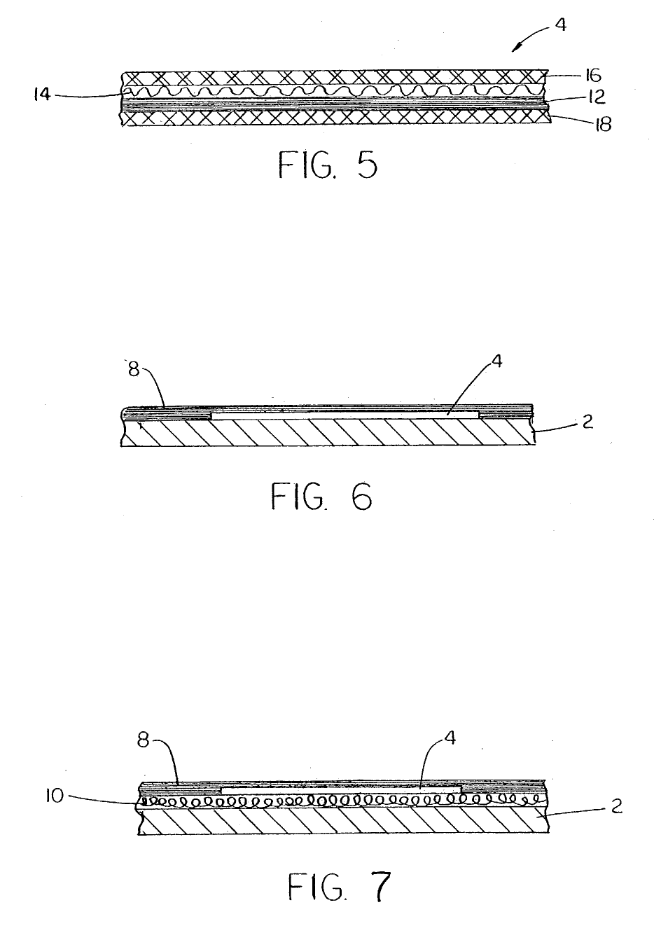

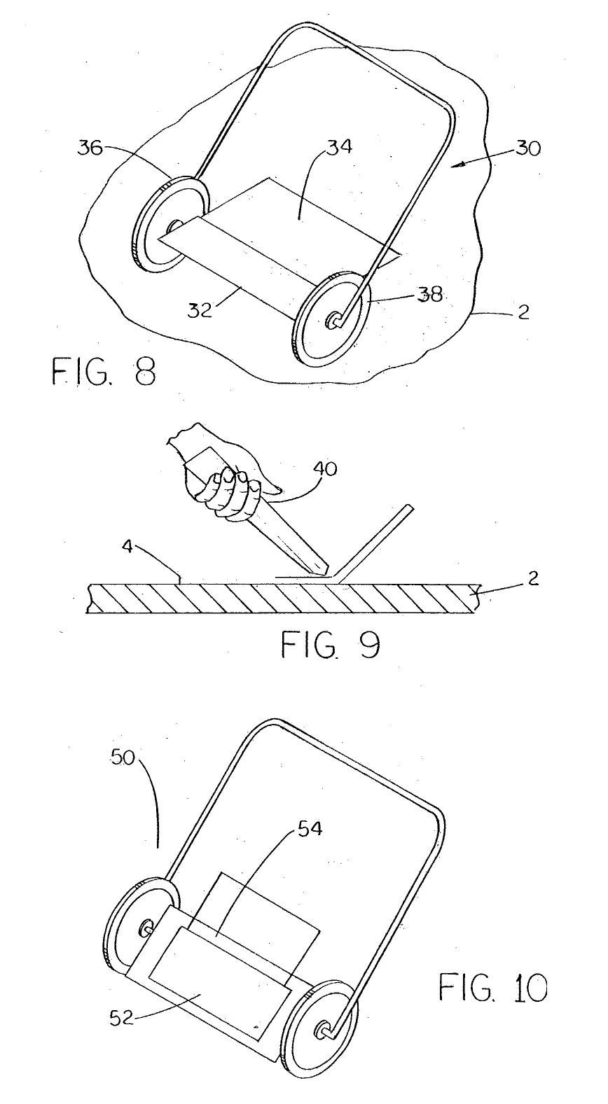

As shown in FIG. 6, in one embodiment of the present invention the indicia containing layer 4 can be printed directly onto the surface 2 instead of being transferred to the surface through a transfer medium. In such an embodiment the films 16 or 18, the bonding coat 6, and the release coat 14 may be omitted. In this embodiment a bonding coat of the type described above may be applied to at least a portion of the surface prior to application of the indicia containing layer. An optional primer layer may also be applied to the surface prior to the application of the indicia containing layer in order to promote ink adhesion to the surface. Surface primers are well known and are commercially available. FIG. 8 shows an exemplary applicator 30 that may be utilized to print the indicia containing layer directly to the surface to be modified. Such an apparatus 30 includes a print head 32 movably mounted such that during the application of the indicia containing layer 4 the print head 32 can be oriented in a substantially parallel manner with respect to the surface 2 to be modified. The print head may a standard laser or ink jet print head of the type well known in the printing art, or a suitable equivalent thereof. The ink may be applied to the surface in a liquid or solid form and the formation of the desired indicia on the surface may be computer controlled using the appropriate hardware and software. The applicator 30 may optionally include a drying apparatus 34 such as a blower fan or heat mechanism. The applicator 30 may further optionally include a print head support apparatus 36. Such an apparatus 36 can include a mechanism 38 for movably supporting the print head above a surface and allowing for smooth movement. Wheels or pads or a similar arrangement can be utilized in such mechanism 38.

Alternatively, as shown in FIG. 10, an applicator 50 can be used to apply an indicia containing layer to a surface. The applicator may also be used to apply a bonding coat to the surface prior to the application of the indicia containing layer. In this construction the applicator may include a dispenser for dispensing and/or distributing the bonding coat onto at least a portion of the surface. Such an applicator 50 can further include a dispenser 52 for distributing or dispensing the indicia containing layer, and a positioning member, which may be an elongated member 54 disposed adjacent to the dispenser 52, to uniformly and temporarily or permanently position the indicia containing layer on a surface to be modified.

In still another embodiment, the dispenser can include a roller mechanism for dispensing an elongated roll of previously printed indicia containing layers onto a surface or multiple surfaces.

In readying the surface 2 for application of an indicia containing layer 4, it is recommended, but not required, that the surface 2 initially be cleaned or stripped to remove dirt, debris or similar waste, as well as any inferior coatings applied on the surface. Conventional cleaners including neutral cleaners, alkaline cleaners, acidic cleaners, cleaners/maintainers, or maintainers including polymeric cleaners, can be utilized. One such cleaner is JohnsonDiversey, Inc.'s UHS Cleaner. Dust mopping, or similar light cleaning may be utilized to remove the majority of the dust, etc. After cleaning and stripping, the indicia containing layer 4 is positioned on at least a portion of the surface 2. If the indicia containing layer 4 is a separate unit which is contained in a discrete package it may be applied by removal of the removable layer 18, thereby exposing the bonding coat 6 and applying pressure to the surface of the indicia containing layer 4. As shown in FIG. 9, a rubbing stick 40 or squeegee can be utilized to uniformly apply the indicia containing layer 4 to the surface 2 and remove any bubbles, wrinkles, etc. After the indicia containing layer 4 is suitably positioned and placed on the surface 2 to be coated, the removable layer 16 can be removed from the indicia containing layer 2. Next, the top coat 8 is disposed over at least a portion of the indicia containing layer 4. As discussed above, one or more layers of the top coat 8 can be applied over the indicia containing layer.

Alternatively, a water release or water slide technique can be utilized to position the indicia containing layer on the surface whereby the indicia containing layer is positioned and moisture is applied to slide the indicia containing layer off of the removable layer 16 or 18.

Maintenance of the surface, and in particular a floor surface containing the appearance enhancement system 1 of the present invention may be handled by utilization of commonly used cleaners including neutral cleaners, alkaline cleaners, acidic cleaners, polymeric cleaners/maintainers and polymeric maintainers. Commonly available products such as JWP Stride Cleaner can be utilized. After the cleaner is applied to the surface, an agitating force sufficient to remove dirt from the indicia containing layer without damaging the layer may be applied. This may be accomplished with commonly used mechanical tools such as auto-scrubbers and buffers, thereby preventing the need for reapplication of the indicia containing layer or danger of an edge flip 60 up as found in the prior art products as shown in FIG. 1.

When it is desirable to remove or change the appearance of the surface containing the appearance enhancement system, common strippers can be used including alkaline strippers such as Bravo1™ stripper available from JohnsonDiversey, Inc., solvent strippers such as Pro Strip™ stripper and Freedom™ stripper available from JohnsonDiversey, Inc. In certain applications the strippers are alkaline/amine based strippers, however any suitable material capable of removing or dissolving the indicia and any coatings can be utilized. Alternatively, dry strippers such as scouring powder, sanding or other aggressive mechanical treatment can be utilized. Forced air, heat and/or mechanical abrasion/scraping can also be utilized. Alkaline based strippers may also be utilized. In the stripping process, the stripper is commonly applied over the entire flooring surface. This is advantageous because it allows the appearance of an entire floor to be modified, for example a laminate flooring may be made to appear to be a wood flooring. The stripper is then left on the flooring surface containing the coatings to be removed for a period of time sufficient to penetrate the indicia containing layer. The stripper along with the coating residues, including the sealers or finishes, is then agitated by the use of a rotary swing machine or common autoscrubber, and then vacuumed or picked up by mop. The indicia containing layer is readily removed along with the waste from the stripping process and should require little or no additional abrasive action. The flooring surface is then prepared as previously described for another application of an indicia containing layer.

Alternative embodiments allow for direct printing of the indicia containing layer directly onto the surface to be coated. In this manner the indicia containing layer is formed directly onto the surface rather than being applied as a preformed image or transferred from another medium, such as a removable protective layer. In such an embodiment, an applicator is positioned and moved across the floor by manual or mechanical means and a print head applies the indicia containing layer directly to the surface.

It should be noted that the layer thicknesses depicted in the figures, is for illustration purposes only and is in no way meant to reflect the actual thickness of each layer or its relative thickness with respect to any other layer.

These embodiments represent a few possibilities for the inventive appearance enhancement and modification system of the present invention. While the principles of this invention have been described in connection with specific embodiments, it should be understood clearly that these descriptions are made only by a way of example and are not intended to limit the scope of the invention.

What is claimed is:

1. A surface modifying structure comprising:
(a) an unsupported indicia containing layer; and
(b) an upper removable protective layer disposed above the unsupported indicia containing layer, wherein the upper removable protective layer comprises paper.

2. The surface modifying structure of claim 1, further comprising a release coating sandwiched between the upper removable protective layer and the unsupported indicia containing layer.

3. The surface modifying structure of claim 2, wherein the unsupported indicia containing layer is reverse printed onto the upper removable protective layer.

4. The surface modifying structure of claim 2, wherein the unsupported indicia containing layer is reverse printed onto the release coating.

5. The surface modifying structure of claim 1, further comprising a lower removable protective layer disposed beneath the indicia containing layer, wherein the lower removable protective layer comprises paper.

6. The surface modifying structure of claim 1, further comprising an adhesive layer sandwiched between the indicia containing layer and the lower removable protective layer.

7. A surface modifying structure comprising a perforated unsupported indicia containing layer.

8. A surface modifying laminate structure comprising:
(a) an unsupported indicia containing layer;
(b) a bonding coat disposed on a bottom surface of the unsupported indicia containing layer;
(c) a lower removable protective layer disposed below the bonding coat;
(d) a release coat disposed on the top surface of the unsupported indicia containing layer; and
(e) an upper removable protective layer disposed above the release coat such that the release coat is sandwiched between the unsupported indicia containing layer and the upper removable protective layer, wherein the upper removable protective layer comprises paper.

9. A modified surface comprising:
(a) a surface;
(b) a base coat disposed on at least a portion of the surface; and
(c) an unsupported indicia containing layer attached to at least a portion of the base coat.

10. The modified surface of claim 9, wherein the unsupported indicia containing layer is attached to the surface by a bonding coat disposed between at least a portion of the base coat and the unsupported indicia containing layer.

11. The modified surface of claim 9, wherein the bonding coat comprises a pressure sensitive adhesive.

12. The modified surface of claim 9, wherein the surface comprises a material selected from a group of materials consisting of vinyl, marble, terrazzo, ceramic, linoleum, wood, metal, plastic, rubber, gypsum board, plaster, concrete, asphalt, stone, vinyl composition tile, and glass.

13. The modified surface of claim 9, wherein the surface is a floor.

14. The modified surface of claim 9, wherein the surface is selected from the group consisting of walls, ceilings, roofs, patios, sidewalks, streets, driveways, billboards, vehicle surfaces, and toy surfaces.

15. The modified surface of claim 9, wherein the unsupported indicia containing layer has a thickness of 8 mils or less.

16. A modified surface comprising:
(a) a surface; and
(b) an unsupported indicia containing layer attached to at least a portion of the surface, wherein the unsupported indicia containing layer is not covered with a top coat.

17. A multi-layered modified surface comprising;
(a) a surface;
(b) a first unsupported indicia containing layer attached to at least a portion of the surface;
(c) a top coat disposed on the first unsupported indicia containing layer; and
(d) a second unsupported indicia containing layer disposed above the top coat.

18. The multi-layered modified surface of claim 17, further comprising an additional top coat disposed on the second unsupported indicia containing layer.

19. The multi-layered modified surface of claim 17, wherein the second unsupported indicia containing layer is a discontinuous layer comprising a plurality of patches.

20. A method of modifying a surface, the method comprising printing an indicia containing layer onto a surface of an architectural structure.

21. The method of claim 20, wherein a bonding coat is applied to at least a portion of the surface prior to printing the indicia containing layer onto the surface.

22. The method of claim 20, wherein the architectural surface is a building surface.

23. The method of claim 22, wherein the building surface is selected from the group consisting of floors, walls, windows, ceilings, roofs and patios.

24. The method of claim 20, wherein the architectural surface is selected from the group consisting of driveways, sidewalks, and roads.

25. The method of claim 20, wherein the indicia containing layer is printed onto the surface with a print head.

26. The method of claim 20, wherein the indicia containing layer is printed onto the surface with a roller.

27. The method of modifying a surface claim 20, further comprising covering at least a portion of the indicia containing layer and at least a portion of the surface in the area adjacent to the unsupported indicia containing layer with a top coat.

28. The method of modifying a surface of claim 20, wherein the surface comprises a material selected from a group of materials consisting of vinyl, marble, terrazzo, ceramic, linoleum, wood, metal, plastic, rubber, gypsum board, plaster, concrete, asphalt, stone, vinyl composition tile, and glass.

29. The method of modifying a surface of claim 18, wherein the unsupported indicia containing layer has a thickness of 8 mils or less.

30. A method of removing an unsupported indicia containing layer from a surface, the method comprising:
(a) applying a stripper to the unsupported indicia containing layer;
(b) applying an agitating force to the unsupported indicia containing layer, wherein the agitating force is sufficient to separate the indicia containing layer from the surface; and
(c) removing the separated indicia containing layer from the surface.

31. A method of maintaining an unsupported indicia containing layer on a surface, the method comprising:
(a) applying a cleaner to the unsupported indicia containing layer;
(b) applying an agitating force to the unsupported indicia containing layer, wherein the agitating force is sufficient to remove dirt from the indicia containing layer without damaging the indicia containing layer; and
(c) removing the cleaner and the dirt from the surface.
